(19) United States
(12) Patent Application Publication
(10) Pub. No.: US 2007/0248493 A1
(43) Pub. Date: Oct. 25, 2007

(54) Furnace for performing dilatometric assays

(75) Inventor: Heinz Baehr, Bad Oeynhausen (DE)

Correspondence Address: CROWELL & MORING LLP;INTELLECTUAL PROPERTY GROUP, P.O. BOX 14300, WASHINGTON, DC, 20044-4300, US

(73) Assignee: Baehr-Thermoanalyse GmbH, Huellhorst (DE)

(21) Appl. No.: 11/790,269

(22) Filed: Apr. 24, 2007

(30) Foreign Application Priority Data
Apr. 24, 2006 (DE) 102006019434.9-52

(51) Int. Cl. G01N 31/12

(52) U.S. Cl. 422/78

(57) ABSTRACT

A furnace for performing dilatometric assays includes a closable sample chamber on which windows for the passage of beams are provided, a sample carrier having a horizontal contact surface for receiving samples situated in the sample chamber and the sample chamber being heatable via one or more heating elements. The heating elements are implemented as essentially flat on the side facing toward the sample carrier and delimit the sample chamber on the top side and the bottom side, the heating elements extending on all sides beyond the sample carrier in the horizontal direction. An especially uniform temperature distribution on the sample is thus ensured.

### CROSS REFERENCE TO RELATED APPLICATIONS

This application claims priority under 35 U.S.C. § 119 to German Patent Application No. 10 2006 019 434.9-52, filed Apr. 24, 2006, the entire disclosure of which is herein expressly incorporated by reference.

### BACKGROUND AND SUMMARY OF THE INVENTION

The present invention relates to a furnace for performing dilatometric assays.

A device for measuring size changes in samples which are subjected to temperature variations, in which a holder for the sample is situated between two optical systems, is known from European patent document EP 1 199 541. The sample is enclosed by a tubular furnace body so that corresponding temperature changes may act on the sample. Generating a uniform temperature field in a furnace for performing such dilatometric assays represents a significant problem. The lines of the temperature gradients are to run as parallel as possible to one another in the area of the sample, and are at least to be symmetrical to the sample, so that uniform temperature conditions result as much as possible over the entire sample.

In known furnaces of the above-mentioned type, up to this point, the approach has been taken of achieving the uniformity of the temperature field in the sample chamber by the design of a tubular furnace body, the heating elements being located in the side walls of the sample chamber and extending over a significant height in accordance with the tubular construction. The disadvantages of known furnaces of this construction are that only an approximately homogeneous temperature field may be achieved in the area of the sample chamber, and the surface of the sample may have a significantly varying spacing to the heating element, depending on where the sample is situated and its geometry. In addition, the sample chamber is only accessible with difficulty and is poorly suited for automatic charging.

The present invention is therefore based on the object of providing a furnace of the type cited above, in which greater uniformity of the temperature field in the sample chamber may be achieved and better accessibility of the sample chamber may be implemented.

This and other objects and advantages are achieved by a furnace according to the present invention, in which the heating elements are implemented essentially flat on the side facing toward the sample carrier and delimit the sample chamber on the top side and the bottom side, the heating elements extending on all sides beyond the sample carrier in a horizontal direction. The special advantage of the furnace is that, viewed in the radial and/or horizontal direction, the top and bottom walls of the sample chamber equipped with the heating elements are much longer than the sample situated centrally between them, so that the smallest interfering influences on the temperature curves result in the center of the sample chamber and a uniform temperature distribution results in the area of the sample.

The uniformity of the temperature field in the sample chamber may be increased even further if the sample chamber has a height between the top and bottom heating elements which is multiple times smaller than the diameter of the sample chamber. In an exemplary embodiment, the sample chamber is hollow cylindrical and circular in accordance with its top and bottom heating elements.

In a further advantageous embodiment according to the present invention, the top and bottom heating elements and the side walls of the sample chamber are backed by thermal insulation.

An advantageous construction of the furnace results through a furnace body divided into a top part and a bottom part, the partition plane between the top part and the bottom part passing through the sample chamber between the top and bottom heating elements. As a result, the top part may be removed from the bottom part of the furnace body, so that the sample chamber is easily accessible and also easily charged using robot technology. The furnace body expediently has a cylindrical basic shape, whose axis is coincident with that of the sample chamber.

An optical window is expediently provided for the beam path of the optical measuring unit on the bottom part of the furnace radially on the diametrically opposite side.

The furnace is designed for operation under vacuum and protective gas. Corresponding precautions such as seal elements on the partition plane and on the optical windows guarantee this type of operation.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a sectional side view of an exemplary embodiment of a furnace according to the present invention;

FIG. 2 shows a sectional top view of the furnace of FIG. 1;

FIG. 3 shows a perspective view of the furnace of FIG. 1;

FIG. 4 shows a perspective view of the furnace of FIG. 1 having an open top part;

FIG. 5 shows a perspective view of a modified exemplary embodiment, and

FIG. 6 shows a perspective view of the furnace of FIG. 5 having an open top part.

### DETAILED DESCRIPTION OF THE DRAWINGS

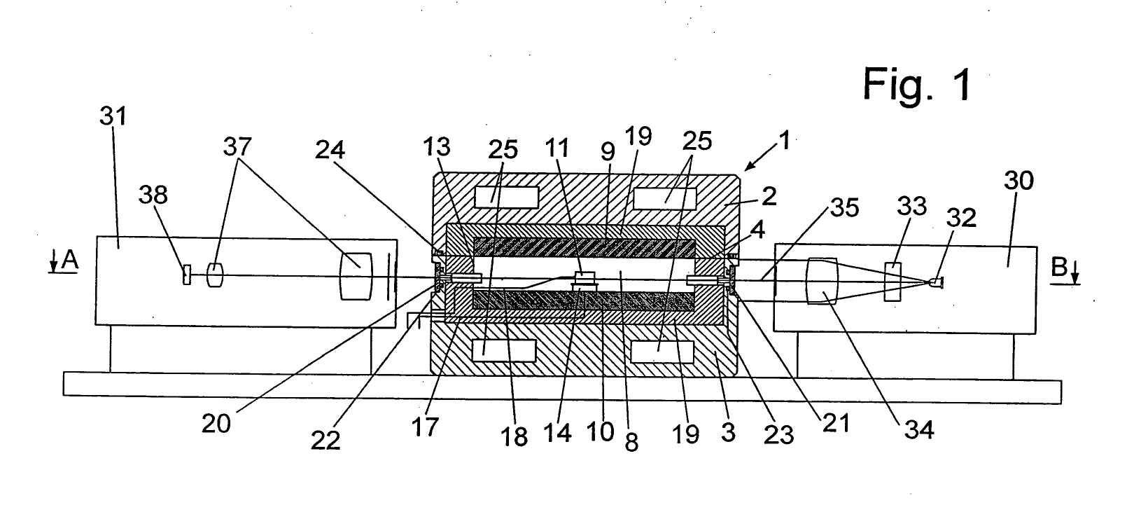

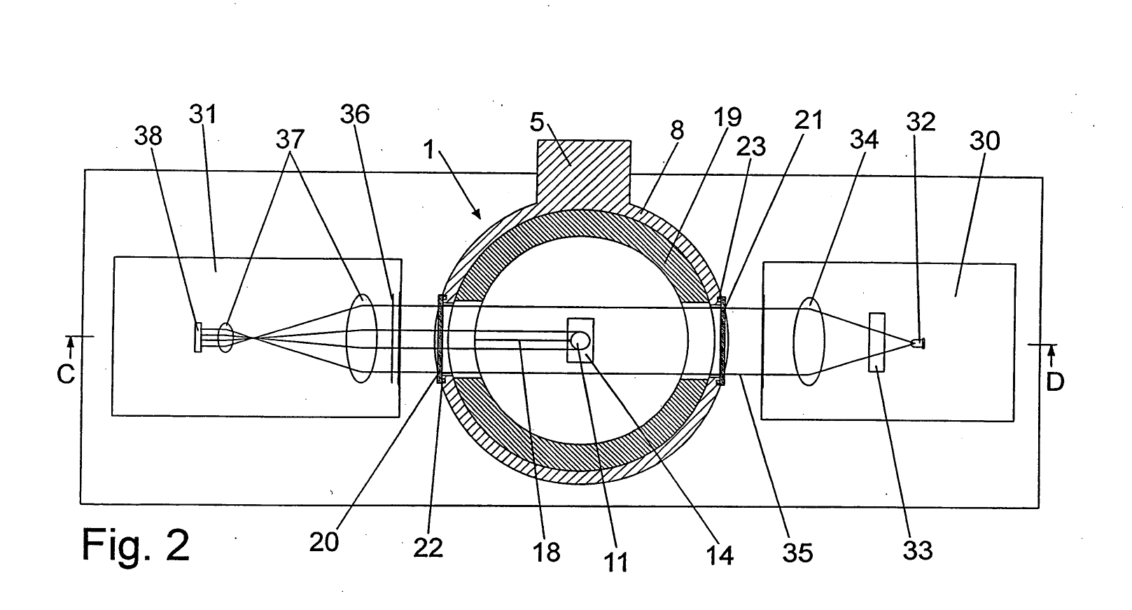

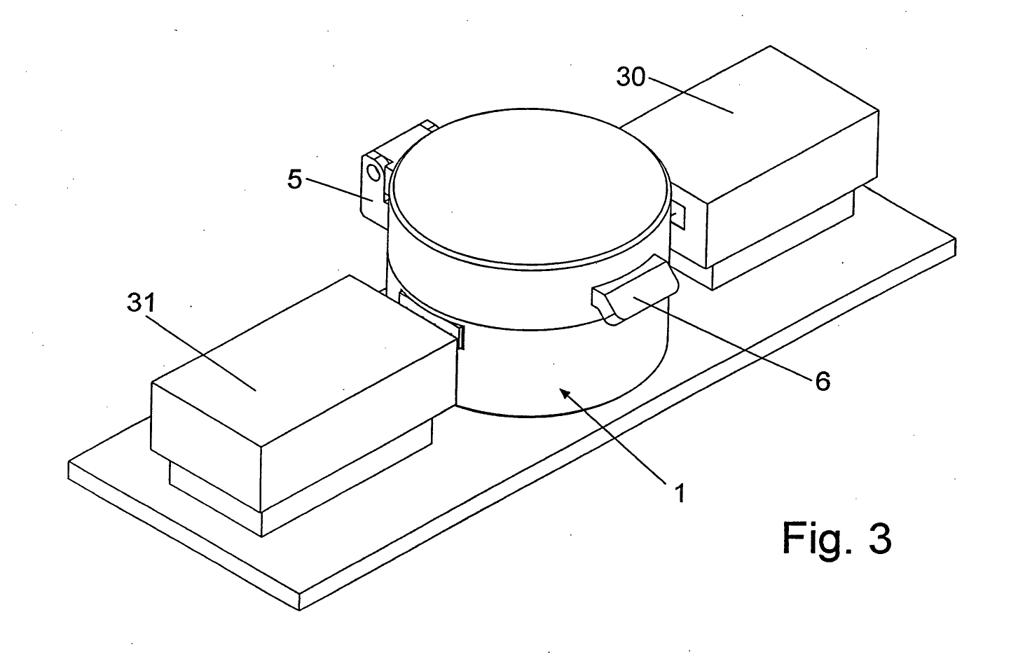

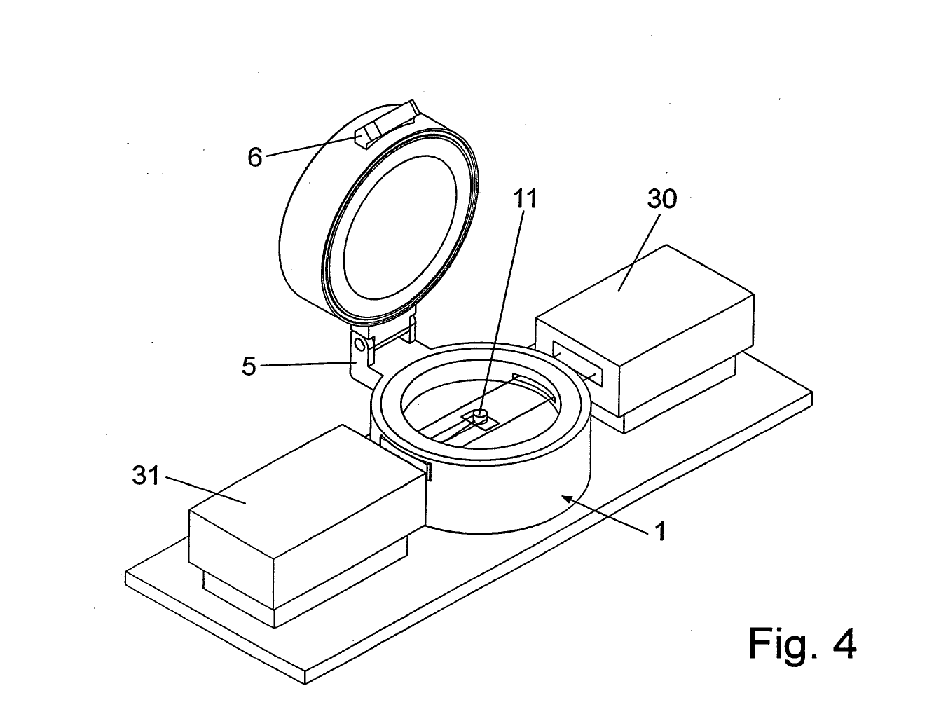

FIGS. 1 through 4 show a furnace 1, which has a cylindrical basic shape. The furnace 1 is divided into a top part 2 and a bottom part 3, which may be lifted apart and put one on top of the other congruently along a horizontally running partition plane 4. The top part 2 may be raised and lowered via a hinge 5, which is attached to the top part 2 and the bottom part 3. A handle 6 is provided on the top part 2 on the diametrically opposite side from the hinge 5.

The top part 2 and the bottom part 3 centrally enclose a sample chamber 8, which has a flat, hollow-cylindrical design and is situated coaxially in the furnace body 1 in the interior of the cylindrical furnace body 1. The partition plane 4 passes through this sample chamber 8 in the horizontal direction between the top part 2 and the bottom part 3. The sample chamber 8 is closed by lowering the top part 2 onto the bottom part 3. The sample chamber 8 is delimited on top by a heating element 9, which may essentially have the shape of a circular disk, for example, which is situated on the bottom of the top part 2 toward the partition plane 4. Analogously, the sample chamber 8 is delimited on the bottom by a bottom heating element 10, the circular heating elements 9 and 10 being congruent with one another.

The hollow-cylindrical sample chamber 8 has a height which is multiple times smaller than the diameter of the sample chamber 8. The sample chamber is enclosed by a lateral wall 13 in the form of a peripheral cylinder mantle inner surface, over which the seam of the partition plane 4 runs. The diameter of the sample chamber 8 is approximately equal to that of the top and bottom heating elements 9 and 10, which are enclosed around their circumference by thermal insulation 19. The thermal insulation in the top part 2 and in the bottom part 3 of the furnace body 1 is situated in such a way that when the top part 2 is closed, the sample chamber 8 is thermally insulated and may be heated to high temperatures of up to 2000° C., for example.

A pedestal 14, which has a flat, horizontal top side, is situated centrally in the sample chamber 8 as a sample carrier. A sample 11 lies on the pedestal 14, which may be put down from above. The sample 11 may be laid at any point of the pedestal 14 in the area of a beam path 35 for a measurement, a uniform temperature profile resulting in the area of the pedestal 14 due to the configuration of the heating elements 9 and 10.

A sample thermocouple 18 is also located in proximity to the pedestal 14 and a regulating thermocouple 17 is located in or on the heating disk 10. Furthermore, a water cooling unit 25 is also provided in the top part 2 and the bottom part 3 for operating the furnace 1 at high temperatures.

An optical system is situated neighboring the furnace 1, which measures the length change of the sample 11 as a function of the temperature.

The optical system includes an optical transmitter 30 and a receiver 31. The transmitter 30 has a light source in the form of a high-power GaN LED 32, which emits light having a very constant wavelength, and a diffusion unit 33, as well as a collimator lens 34, which emits the light in parallel. The parallel beam path 35 thus generated passes through a window 21 implemented in the bottom part 3 and is incident there on the sample 11. Only beams which are not incident on the sample 11 exit again through a window 20, which is situated on the side of the bottom part 3 diametrically opposite the window 21.

The window 21 is attached via a seal 23, and the window 20 is attached via a seal 22 to a side wall of the sample chamber 8. Furthermore, the top part 2 is sealed by a seal 24 on the bottom part 3, so that the sample chamber 8 may be provided with a gas filling or with a vacuum.

Shadow beams thus result, which are first incident on a filter 36 on the receiver side 31. The filter 36 may be implemented in such a way that it only transmits the beams having the wavelength emitted by the high-power GaN LED 32. Subsequently, the beams pass through a telecentric optical system 37 having one or more lenses and are then incident on a high-speed linear CCD sensor 38. The signals of the sensor 38 are relayed for analysis to an A/D converter and then to a digital boundary recognition processor and to the CPU.

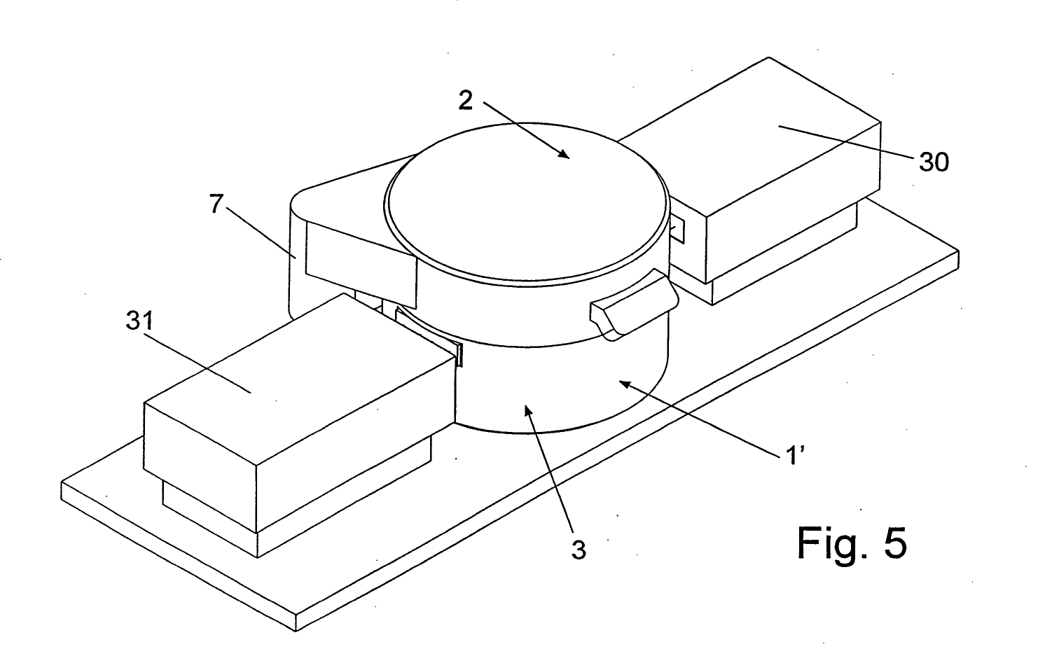

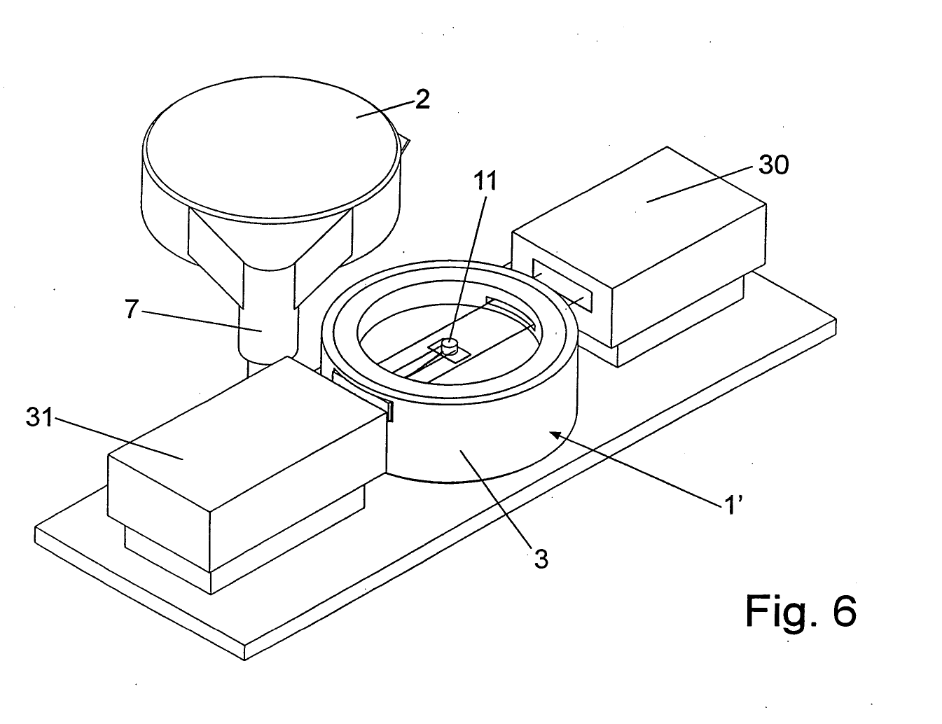

A modified embodiment of a furnace 1′ is shown in FIGS. 5 and 6, in which a lift and pivot mechanism 7 is provided instead of the hinge 5. The top part 2 is raised and pivoted away laterally from the bottom part 3 by the lift and pivot mechanism 7, so that the sample chamber 8 is accessible from above to insert or remove the sample 11. Otherwise, the furnace 1′ is implemented as in the preceding exemplary embodiment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A furnace for performing dilatometric assays comprising:
a closable sample chamber, on which windows are provided for the passage of beams;
a sample carrier, having a horizontal contact surface for receiving samples, situated in the sample chamber for heating the sample chamber; and
at least one heating element that is substantially flat on a side facing toward the sample carrier and delimits the sample chamber on a top side and a bottom side thereof, the at least one heating element extending on all sides in the horizontal direction beyond the sample carrier.

2. The furnace according to claim 1, wherein the length or the diameter of the heating element is multiple times longer than the contact surface of the sample carrier.

3. The furnace according to claim 1, wherein a top disk-shaped heating element is provided on a top part of the furnace and a bottom disk-shaped heating element is provided on a bottom part of the furnace, the top part configured to be removable from the bottom part.

4. The furnace according to claim 3, wherein a horizontal partition plane between the top part and the bottom part passes through the sample chamber between the top and bottom heating elements.

5. The furnace according to claim 1, wherein the sample chamber has a height between a top heating element and a bottom heating element which is multiple times smaller than the diameter of the sample chamber.

6. The furnace according to claim 1, wherein the sample chamber is hollow-cylindrical and the at least one heating element includes top and bottom heating elements that are circular.

7. The furnace according to claim 1, wherein the at least one heating element and side walls of the sample chamber are backed with thermal insulation on a side facing away from the sample chamber.

8. The furnace according to claim 1, wherein the sample chamber has a cylindrical shape and the sample carrier is situated radially centered in the sample chamber.

9. The furnace according to claim 1, wherein a light source is situated adjacent to a first window on a bottom part of the furnace and a second window is provided on the diametrically opposite side of the bottom part of the furnace, which is adjacent to a sensor for detecting the length of the sample.

10. The furnace according to claim 2, wherein a top disk-shaped heating element is provided on a top part of the furnace and a bottom disk-shaped heating element is provided on a bottom part of the furnace, the top part configured to be removable from the bottom part.

11. The furnace according to claim 10, wherein a horizontal partition plane between the top part and the bottom part passes through the sample chamber between the top and bottom heating elements.

12. The furnace according to claim 2, wherein the sample chamber has a height between a top heating element and a bottom heating element which is multiple times smaller than the diameter of the sample chamber.

13. The furnace according to claim 2, wherein the sample chamber is hollow-cylindrical and the at least one heating element includes top and bottom heating elements that are circular.

14. The furnace according to claim 2, wherein the at least one heating element and side walls of the sample chamber are backed with thermal insulation on a side facing away from the sample chamber.

15. The furnace according to claim 2, wherein the sample chamber has a cylindrical shape and the sample carrier is situated radially centered in the sample chamber.

16. The furnace according to claim 2, wherein a light source is situated adjacent to a first window on a bottom part of the furnace and a second window is provided on the diametrically opposite side of the bottom part of the furnace, which is adjacent to a sensor for detecting the length of the sample.

17. The furnace according to claim 3, wherein the sample chamber has a height between a top heating element and a bottom heating element which is multiple times smaller than the diameter of the sample chamber.

18. The furnace according to claim 3, wherein the sample chamber is hollow-cylindrical and the at least one heating element includes top and bottom heating elements that are circular.

19. The furnace according to claim 3, wherein the at least one heating element and side walls of the sample chamber are backed with thermal insulation on a side facing away from the sample chamber.

20. The furnace according to claim 3, wherein the sample chamber has a cylindrical shape and the sample carrier is situated radially centered in the sample chamber.
